(19) United States
(12) Patent Application Publication
(10) Pub. No.: US 2013/0341531 A1
(43) Pub. Date: Dec. 26, 2013

(54) EMITTER ASSEMBLY

(71) Applicants: Bob Bonham, Oakville (CA); Rick Hornung, Cobourg (CA)

(72) Inventors: Bob Bonham, Oakville (CA); Rick Hornung, Cobourg (CA)

(21) Appl. No.: 13/529,606

(22) Filed: Jun. 21, 2012

(51) Int. Cl. B05C 9/12

(52) U.S. Cl. CPC B05C 9/12
USPC 250/492.1

(57) ABSTRACT

An emitter assembly for use in curing of paints or other coatings includes a generally sealed outer enclosure having an inlet; a cooling system for directing a cooling fluid via the inlet to inside the outer enclosure to maintain at least the exterior surfaces of the outer enclosure below a first threshold temperature; and an inner enclosure contained by the outer enclosure and enclosing an emitter bulb, the inner enclosure configured to at least partially shelter the emitter bulb from the flow of cooling fluid to maintain the emitter bulb at or above a second threshold temperature.

### FIELD OF THE INVENTION

The present application relates generally to processes for painting and coating surfaces, and more particularly to an emitter assembly for use during a process of curing paint or other coatings on a work surface.

### BACKGROUND OF THE INVENTION

One of the fastest growing segments in the paint and coatings industry is ultraviolet (UV) processing to cure a paint, or other coating such as an adhesive, on wood, metal, plastic or some other substrate material. UV cure coatings are increasingly being used in place of conventional high heat processing to produce improved coatings, to cut the overall cost of coating operations (especially the natural gas costs to bake cure), and to reduce the environmental impact of the coating.

These UV cured coatings are generally cured by a UV light source, such as for example a mercury arc lamp, a metal halide arc lamp, a UV-LED (Light Emitting Diode) lamp, a fluorescent UV lamp etc. Such lamps, or emitter assemblies, are generally embodied as emitter bulbs housed in unsealed enclosures, and that employ fans to pull air directly from the surrounding environment for cooling.

Known emitter assemblies tend to undesirably permit explosive and/or flammable materials (such as paint fumes, solvents, dust) to enter into the assemblies where the hot emitter bulbs are housed. In some instances the ingress of such materials can lead to ignition of the materials within the assemblies because of arcing caused by high voltages and/or high temperatures of the lamp components. Therefore, many existing lamps are generally not suitable for use in environments classified as hazardous locations, such as in places in which it is possible that flammable gases or vapours could exist in quantities sufficient to produce an explosive or ignitable mixture under normal operating conditions. One such environment is an auto body paint booth in which flammable paint fumes and solvents are commonplace.

It is an object of an aspect of the following to provide an emitter assembly that mitigates or obviates at least one of the above-mentioned disadvantages.

### SUMMARY OF THE INVENTION

According to an aspect, there is provided an emitter assembly comprising: a generally sealed outer enclosure having an inlet; a cooling system for directing a cooling fluid via the inlet to inside the outer enclosure to maintain at least the exterior surfaces of the outer enclosure below a first threshold temperature; and an inner enclosure contained by the outer enclosure and enclosing an emitter bulb, the inner enclosure configured to at least partially shelter the emitter bulb from the flow of cooling fluid to maintain the emitter bulb at or above a second threshold temperature.

Advantageously, provision of the generally sealed outer enclosure inhibits ingress of uncontrolled fluids, such as paint fumes, solvents, and dust in the immediately surrounding atmosphere in which the emitter assembly is being used. For maintaining the temperature of at least the exterior surfaces of the outer enclosure (those surfaces that are exposed to the immediately surrounding atmosphere), the inlet permits entry of a cooling fluid. The cooling fluid flows from an external source such as a canister or compressed air system of a building via a hose, or some other source. The cooling fluid may be clean, filtered, instrument-quality air, or an inert gas, or some other suitable fluid. The inner enclosure provides some sheltering from the cooling fluid in order to enable the emitter bulb to reach a temperature at which it can operate effectively.

### BRIEF DESCRIPTION OF THE DRAWINGS

Embodiments will now be described more fully with reference to the accompanying drawings in which:

FIG. 1 is a front partial cutaway perspective view of an emitter assembly, according to an embodiment;

FIG. 2A is an exploded perspective view of the emitter assembly of FIG. 1;

FIG. 2B is an alternative perspective view of an inner enclosure of the emitter assembly of FIG. 1;

FIG. 3 is a sectional view of the emitter assembly of FIG. 1, taken along lines 3-3 of FIG. 1;

FIG. 4 is a magnified, partial sectional view of the emitter assembly of FIG. 1, taken along lines 3-3 of FIG. 1;

FIG. 5 is an exploded perspective view of an alternative emitter assembly, according to an embodiment;

FIG. 6 is a sectional view of part of the emitter assembly of FIG. 5;

FIG. 7A is a front perspective view of the emitter assembly of FIG. 5;

FIG. 7B is a rear perspective view of the emitter assembly of FIG. 5;

FIG. 8 is a sectional view of another alternative emitter assembly, according to an embodiment;

FIG. 9 is a sectional view of yet another alternative emitter assembly, according to an embodiment;

FIG. 10 is a sectional view of still another alternative emitter assembly, according to an embodiment;

FIG. 11 is a sectional view of another alternative emitter assembly, according to an embodiment;

FIG. 12 is a sectional view of yet another alternative emitter assembly, according to an embodiment; and

FIG. 13 is a perspective view of the emitter assembly of FIG. 12 being inserted into a pipe.

### DETAILED DESCRIPTION OF THE EMBODIMENTS

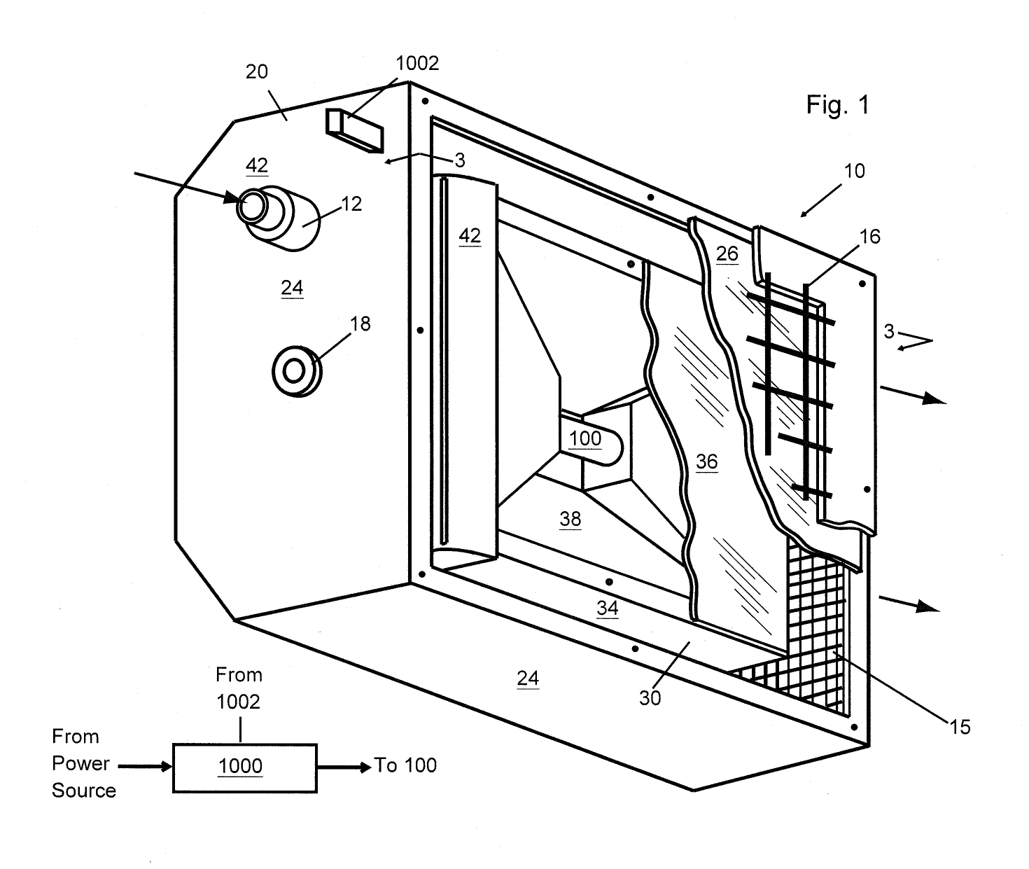

FIG. 1 is a front partial cutaway perspective view of an emitter assembly 10, according to an embodiment. Emitter assembly 10 has an outer enclosure 20 that includes walls 24 and a window 26. In this embodiment, walls 24 are made of one or more sheets of metal, and window 26 is a pane of filter glass. The walls 24 and window 26 are referred to collectively herein as an interface that separates the interior of the outer enclosure 20 from the surrounding operating environment.

The outer enclosure 20 is substantially sealed about its periphery to substantially block the uncontrolled entry of fluids such as gases in the surrounding atmosphere (for example, air, fumes and the like) into its interior. In this embodiment, edges of the walls 24 and regions at which the walls 24 meet the window 26, are substantially sealed.

An inlet 12, suitable for passing fluid such as gas provides a passageway through the interface into the interior of the outer enclosure 20. The inlet 12 is dimensioned to permit a sealed connection of a pipe or hose for conveying a cooling fluid from an external source (not shown) into the interior of the outer enclosure 20. In this embodiment, the emitter assembly 10 is adapted to receive a gaseous cooling fluid such as a clean, filtered, instrument-quality cooling gas via a hose. In this embodiment, the cooling gas is conveyed to an air knife 42, which distributes the cooling gas within the outer enclosure 20. As will be described below, the temperature and flow of the cooling gas are controlled to maintain the interface below a first threshold temperature. In this embodiment, the first threshold temperature is the temperature of auto ignition of explosive or flammable gases that may be in the atmosphere on the exterior of the outer enclosure 20, such as paint fumes, solvents and the like. It may be required that the temperature of the interface is less than the allowable temperature specified in a governing safety code, for example as set out in the National Fire Prevention Association's (NFPA) NFPA 496 standard.

For example, a device certified for a “T4” temperature rating cannot have an external temperature that exceeds 130 degrees Celsius. This temperature can be controlled by controlling the flow rate of the cooling fluid being introduced into the outer enclosure 20, and/or by controlling the temperature of the cooling fluid being introduced into the outer enclosure 20. It will be appreciated that the greater the rate of flow into outer enclosure 20, the greater the amount of heat that can be carried from the outer enclosure 20 by the cooling fluid. Also, if the cooling fluid is itself cooled, it will be able to absorb more heat per unit volume of cooling fluid. The cooling fluid rate and temperature variables can be established to suit the environment in which the emitter assembly 10 is to be operated within. As will be understood, a cooler operating environment would require a lower flow rate, all other factors being equal. Similarly, a cooler operating environment would not require as low a temperature of cooling fluid, all other factors being equal.

The system, including the emitting assembly and the cooling fluid supply, can be configured to operate within a defined temperature range and/or can include control components for enabling it to be controllable for handling environments of greater temperature variance. For example, control could include sensing one or more temperatures associated with the emitter assembly components and then using a controller to operate valves or similar devices to regulate the rate of flow of the cooling fluid within the enclosure. The flow of the cooling fluid would be increased and decreased as required to maintain the target temperatures. In one embodiment, a programmable logic controller (PLC) may be used to cycle a solenoid valve on and off based on temperature data received from one or more temperature sensor associated with the emitter assembly. The PLC and solenoid valve may be co-housed with power control components such as those referred to below.

In this embodiment, a metal grid 16 overlies the exterior-facing surface of window 26 and provides a measure of protection of window 26 against breaking in the event of a collision with some other object during transportation or use of the emitter assembly 10.

Emitter assembly 10 also has an inner enclosure 30 that is itself contained within outer enclosure 20. Inner enclosure 30 includes walls 34 and a window 36. In this embodiment, walls 34 are made of one or more sheets of metal, and window 36 is a pane of filter glass. Walls 34 and window 36 cooperate to facilitate sheltering the interior of the inner enclosure 30 somewhat from the maximum cooling effects of the cooling gas being provided via the inlet 12 and air knife 42 into the outer enclosure 20, as will be described. Inner enclosure 30 supports and encloses an emitter bulb 100, in this embodiment an ultraviolet (UV) bulb, and includes terminals to which the leads of the emitter bulb 100 may be electrically connected to receive electrical power.

Electrical power is provided to the emitter assembly 10 via a power controller 1000. Power controller 1000 receives electrical power from a standard alternating current (AC) power source such as a power distribution system (PDS) in a factory or workshop. The power controller 1000 may condition the power before selectively providing the power to the emitter assembly 10 for operation. The power controller receives an electrical signal from a differential fluid pressure sensor 1002 that is positioned with respect to the outer enclosure 20 to sense the difference in fluid pressure inside of outer enclosure 20 from the fluid pressure in the operating environment outside of the outer enclosure 20. The differential fluid pressure sensor 1002 in this embodiment senses respective gas pressures on the inside and the outside of outer enclosure 20. The electrical signal provided by differential fluid pressure sensor 1002 signals the power controller 1000 as to difference in the gas pressures on the inside and the outside of outer enclosure 20.

The power controller 1000 is in control of a switch (not shown) that is normally open. The normally open switch prevents power from the power source from flowing to the emitter bulb 100. Only while the fluid pressure on the inside of the emitter assembly 10 is greater than the fluid pressure on the outside of the emitter assembly 10, as signaled to the power controller 1000 by the differential fluid pressure sensor 1002, does the power controller 1000 cause the switch to close to permit power to flow to the emitter assembly 10. Ensuring a relatively positive fluid pressure within the emitter assembly 10 prior to permitting operating of the emitter assembly 10 prevents the flow into the emitter assembly 10 of explosive and/or flammable fluids such as gases that may be in the environment surrounding the emitter assembly 10 while the emitter bulb 100 is activated.

Inner enclosure 30 also supports a reflecting structure 38 of glass mirrors or polished metal surfaces, that reflects UV radiation from a powered emitter 100 away from the interior of the inner enclosure 30 towards the window 36 of the inner enclosure 30.

An outlet 14 on a side of the outer enclosure 20 that is opposite to the air knife 42 similarly provides a passageway through the interface from the interior to the exterior of the outer enclosure 20, and permits the exhausting of the cooling fluid out of the interior of the outer enclosure 20. In this embodiment, the outlet 14 is simply one or more holes through wall 24 with a certified spark/flame arrestor such as a metallic filter 15 at the holes and in the exhaust path. A porous metal such as metallic foam, or other suitable material, may alternatively be used for arresting sparks and/or flames. The spark/flame arrestor functions to block sparks or flames that may originate within the interior of the outer enclosure 20 before they get outside of the outer enclosure 20, so that flammable gases or other materials on the exterior of the outer enclosure 20 are not ignited by such sparks or flames.

The cooling fluid is continually passed into the outer enclosure 20 at a rate that maintains the positive pressure within the outer enclosure 20, relative to outside the outer enclosure 20. This positive pressure provides additional guard against fluids and other flammable materials entrained in the air on the outside of the outer enclosure 20 entering the outer enclosure 20.

On each of two opposed walls 24 are affixed pivot structures 18 for cooperating with respective arms of a frame (not shown in FIG. 1) to support the emitter assembly 10 and to permit pivoting of the emitter assembly 10 relative to the frame in order to enable a user of the emitter assembly 10 to direct the emission of radiation from an enclosed emitter bulb 100 towards a work piece. The frame may provide additional degrees of freedom to an operator, such as telescoping for elevation adjustments, and rotation.

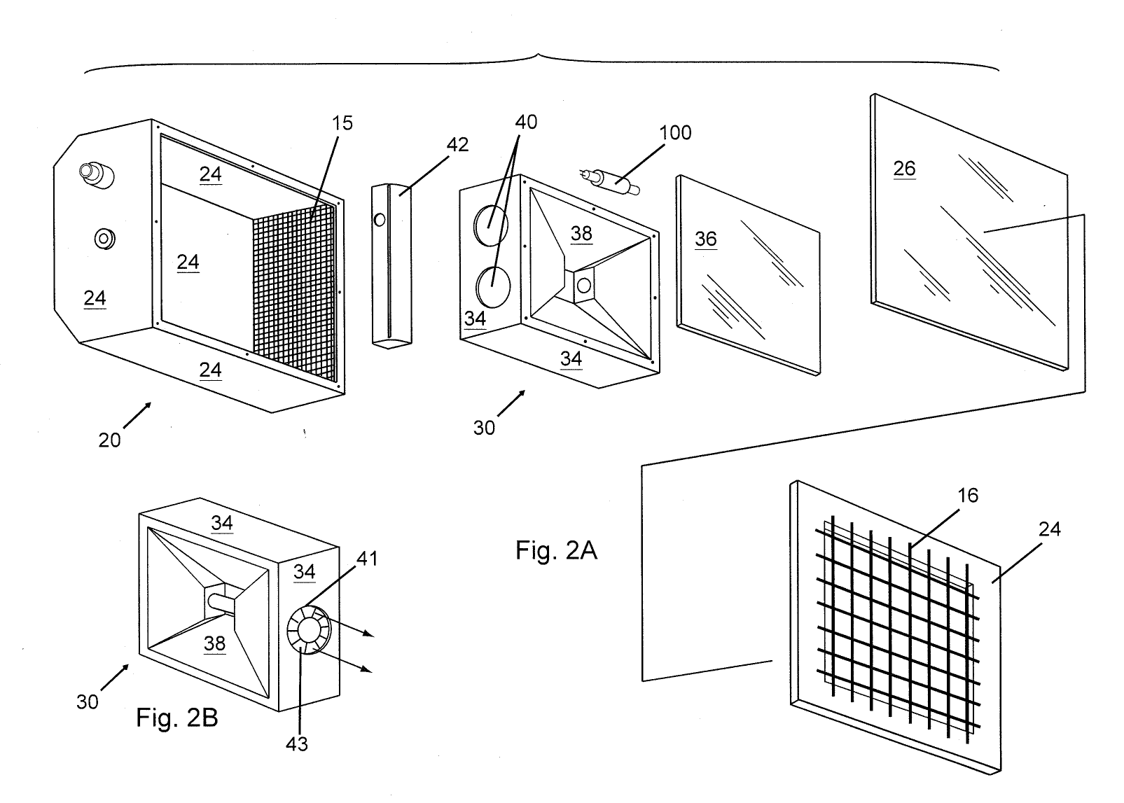

FIG. 2A is an unassembled perspective view of emitter assembly 10 of FIG. 1, and FIG. 2B is an alternative perspective view of the inner enclosure 30 of the emitter assembly 10. As can be seen in FIG. 2B, a fan 43 is positioned at the outlet and, when powered, pulls cooling fluid through the inner enclosure 30.

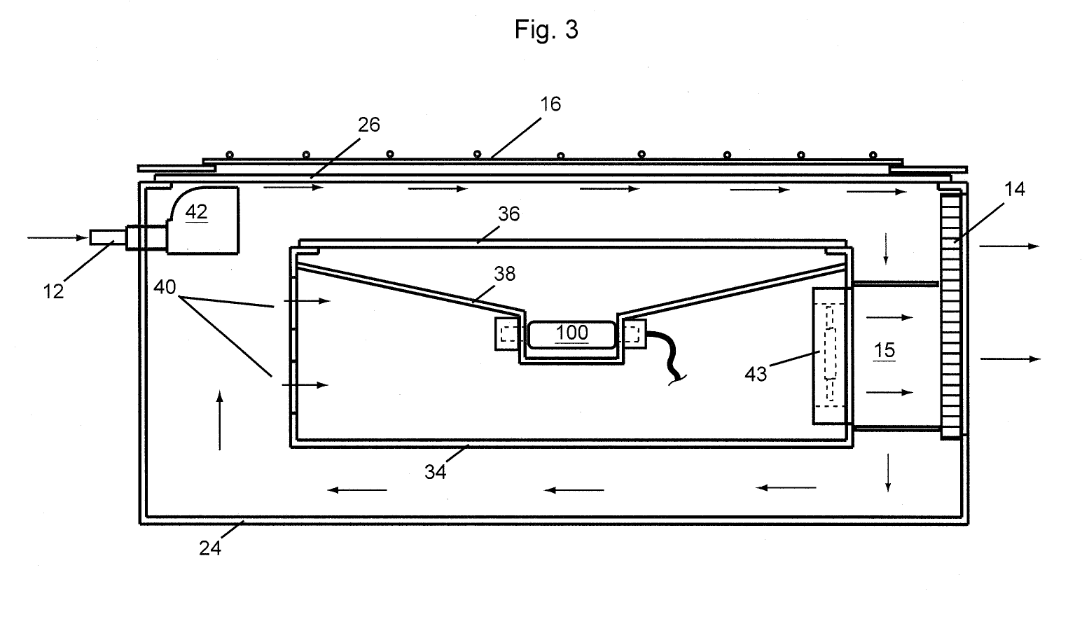

As can be seen in the sectional view of FIG. 3, the interior of the inner enclosure 30 is partially sheltered by the walls 34 and window 36 from maximum cooling effects of the cooling fluid entering the outer enclosure 20 via the inlet 12. This permits the emitter bulb 100 to rise in temperature once power is applied to it to at least a second threshold temperature, since heat is not being drawn away as rapidly. In this embodiment, the second threshold temperature is the temperature at which the emitter bulb 100 is able to operate. Below this temperature, the emitter bulb 100 will either fail to ignite to produce any radiation, or will produce reduced amounts of useful UV radiation. Preferably, the emitter bulb 100 is maintained below a predetermined upper temperature limit, so as to not exceed an efficient operating temperature of the emitter bulb 100. For example, the operating temperature of a typical mercury halide medium pressure bulb is between 900 degrees Centigrade and 1000 degrees Centigrade, as would be measured at the surface of the glass wall of the emitter bulb 100. The operating temperature range will vary across manufacturers, makes and models of emitter bulb 100.

In order to permit some cooling fluid into and out of the inner enclosure 30, there is provided at least one inlet port 40, and at least one outlet port 41. In this embodiment the ports 40 and 41 are positioned such that cooling fluid is directed behind the reflecting structure 38 to carry heat away from the vicinity of the reflecting structure 38.

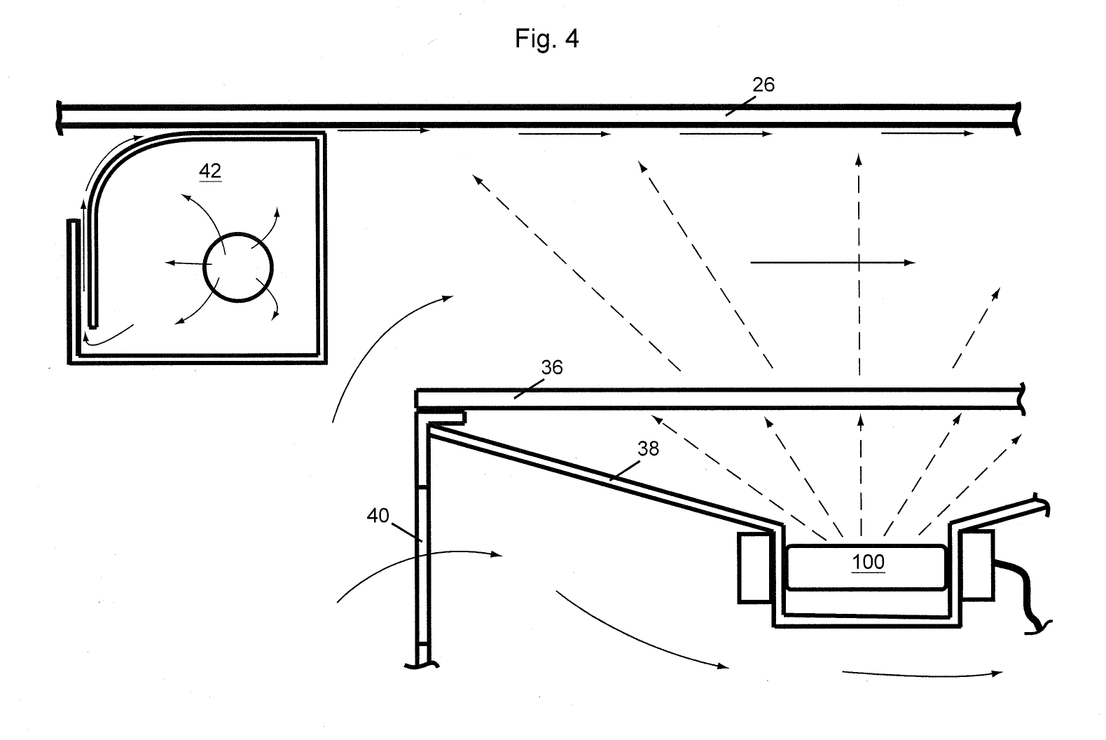

FIG. 4 is a magnified partial sectional view of the emitter assembly 10. As shown in FIG. 4, when emitter bulb 100 is activated, radiation emitted by the emitter bulb 100 passes through window 36 of the inner enclosure 30 and subsequently is incident on window 26 of the outer enclosure 20 before the radiation proceeds to the exterior of the outer enclosure 20 through the window 26 for application to a coated surface for curing. Incident radiation from the emitter bulb 100 onto the window 26 causes a great deal of heat to accumulate at window 26, and the temperature of window 26 accordingly will rise. If the temperature at the window 26 (or any other part of the interface) should rise to the auto-ignition temperature of a flammable material such as gas, for example paint fumes or solvents in the atmosphere surrounding the emitter assembly 10 (i.e., in an auto body paint booth, for example), the flammable material could ignite causing an explosion or fire.

Therefore, to keep the temperature from rising to the auto-ignition temperature, an air knife 42 is positioned within the outer enclosure 20 adjacent to one side of the window 26 and outside of the inner enclosure 30. The air knife 42 advantageously enables controlled direction of the cooling fluid being provided into the interior of the exterior enclosure 20.

The air knife 42 receives the cooling fluid being supplied via the inlet 12 and directs it through a narrow, elongate passageway of the air knife 42. Just outside of the narrow elongate passageway of the air knife 42, the directed cooling fluid travels along a curved surface of the air knife 42 to create a rapid, laminar flow of the cooling fluid. The laminar flow is directed across the interior-facing surface of the window 26. With the rapid laminar flow, the cooling fluid against and adjacent to the window 26 does not billow but instead rushes at a rapid rate across the window 26 in a continuous sheet to absorb heat and carry it away from the window 26 thereby to cool the window 26. When a large volume of the cooling gas travelling in a laminar flow carrying the heat generated from the radiation being incident on the window 26 reaches the other side of the window 26, it soon reaches one of walls 24 and can safely be dispersed with cooler cooling fluid that is within the outer enclosure 20 and away from the window 26. The temperature within the outer enclosure 20 as a whole is controlled by permitting exhausting via the exhaust outlet 14 of the heated cooling fluid.

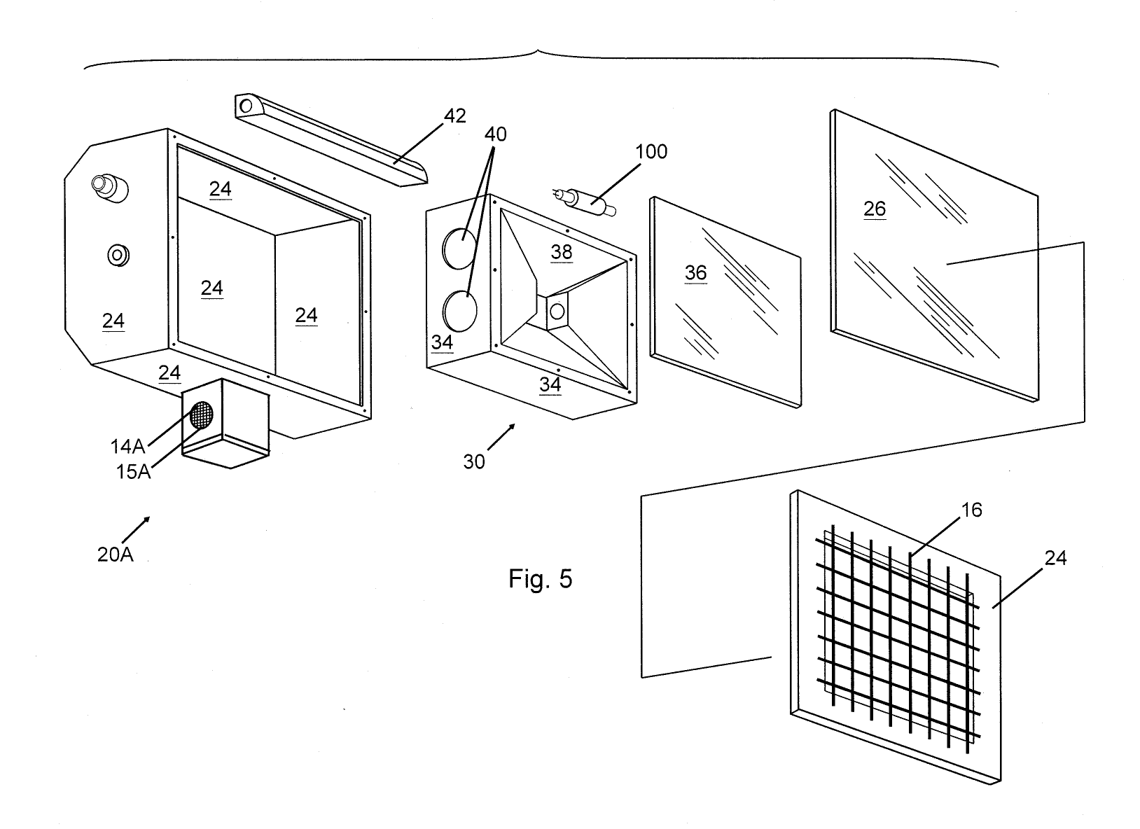

FIG. 5 is an exploded perspective view of an alternative emitter assembly 10A. Emitter assembly 10A is much the same in construction as emitter assembly 10. However, outer enclosure 20A differs from outer enclosure 20 in that it has an outlet 14A that further comprises an externally-mounted box with holes. The box configuration permits more controlled directing of the heated cooling fluid exiting the outer enclosure 20A. Similar to filter 15, filter 15A is placed adjacent to the holes as a flame/spark arrestor. As described above, another material such as a porous metal may be employed for flame/spark arresting.

Also in FIG. 5, it can be seen that air knife 42A directs cooling fluid across the window 26 from a position within the outer enclosure 20A that is opposite to the outlet 14A.

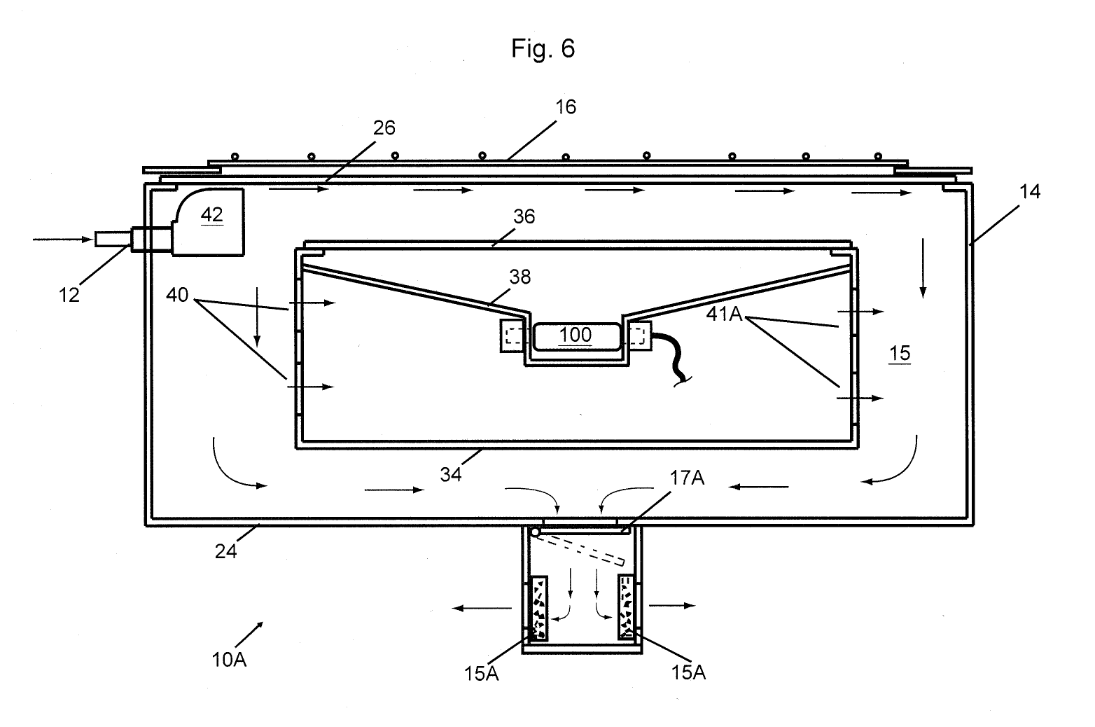

A variation on the alternative emitter assembly 10A with outlet 14A is shown in the sectional view of FIG. 6. In this embodiment, the air knife 42A is positioned to direct cooling fluid across the window 26 in a direction that is transverse to the direction shown in FIG. 5. As can be seen, outlet 14A further includes a flap 17A that is spring-operated to be biased against the hole from the outer enclosure 20A into the outlet 14A so as to block the hole. The spring strength is chosen to permit opening of the flap only when the fluid pressure within the outer enclosure 20A exceeds the fluid pressure within the outlet 14A by a threshold amount. In addition to the maintenance of the positive fluid pressure as described above, the spring provides a further guard against materials such as solvents or paint gases entering the outer enclosure 20A in the event that the fluid pressure within the outer enclosure 20A drops for some reason relative to the fluid pressure within the outlet 14A.

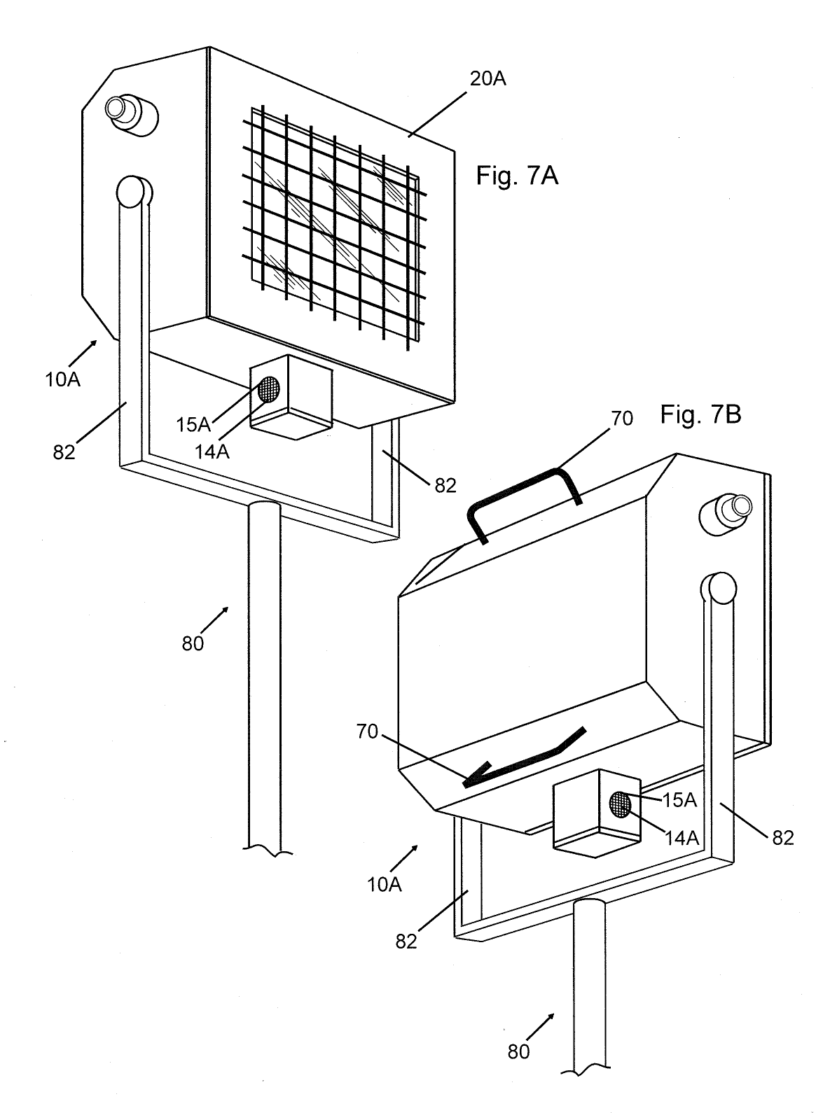

The front and rear perspective views of FIGS. 7A and 7B show handles 70 extending from rearward-facing walls 24A of the outer enclosure 20A. Handles 70 facilitate pivoting of the emitter assembly 10A by a user so that the radiation may be directed by a user towards a work piece. Also shown is the frame 80 with frame arms 82 for cooperating with pivot structures 18.

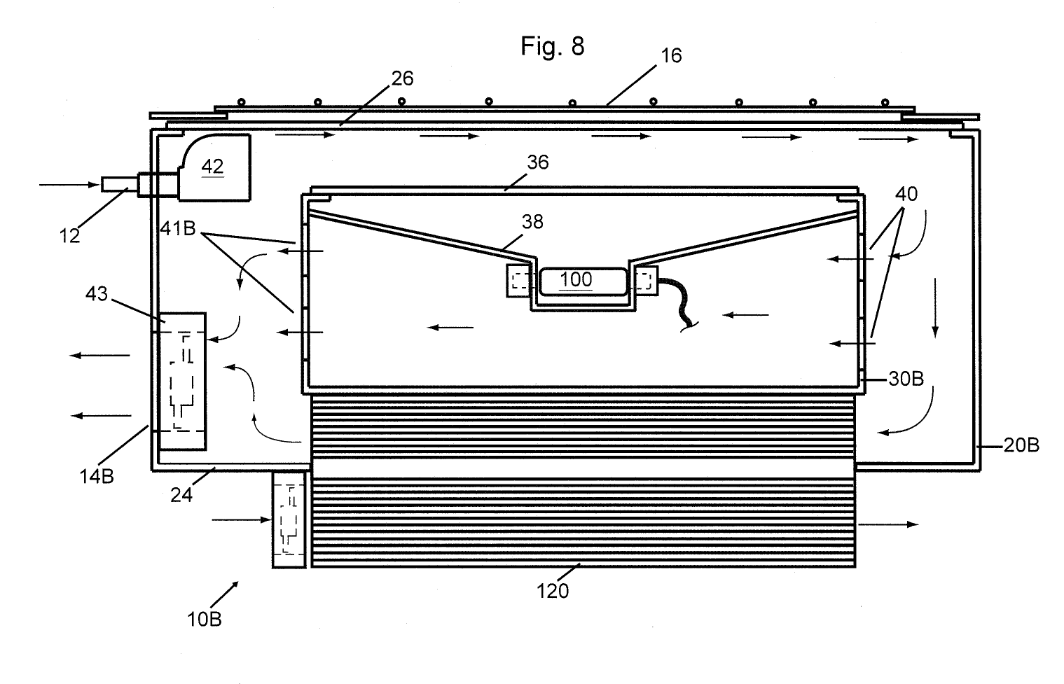

FIG. 8 is a sectional view of another alternative emitter assembly 10B. In this embodiment, a metal heat sink 120 is provided that crosses the interface between the interior and exterior of an outer enclosure 20B. Heated cooling fluid flowing through the interior of outer enclosure 20B is caused to pass alongside the portion of heat sink 120 that is inside of the interior of the outer enclosure 20B, and heat from the heated cooling fluid is thereby carried through the heat sink 120 to the exterior of the outer enclosure 20B. In this embodiment, the cooling fluid within the interior of the outer enclosure 20B is also permitted to pass through the inner enclosure 30B. The cooling fluid having passed through the inner enclosure 30B exits the outer enclosure 20B via the interior of the outer enclosure 20B.

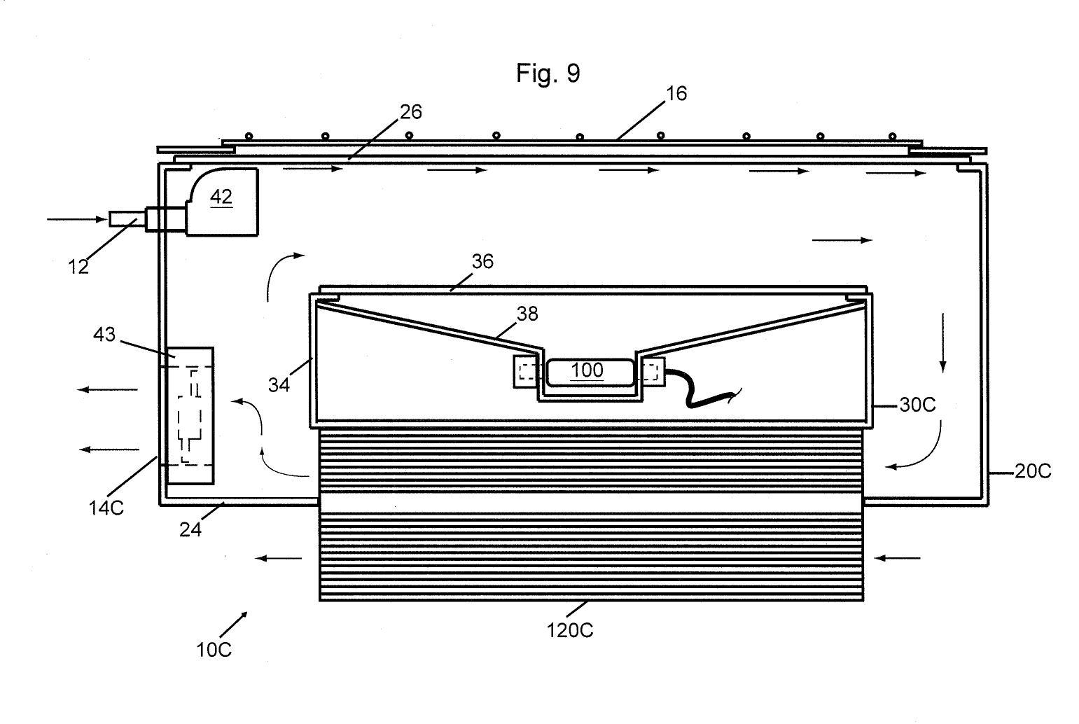

FIG. 9 is a cutaway view of another alternative emitter assembly 10C. In this embodiment, the configuration is similar to that of the embodiment shown in FIG. 8, but there are no ports in inner enclosure 30C to permit cooling fluid to enter the interior of inner enclosure 30C. The heat sink 120C in contact with a wall 34 of the inner enclosure 30C serves to remove some heat from the inner enclosure 30C resulting from the emitter 100, as does the flow of the cooling fluid between the outer and inner enclosures 20C, 30C.

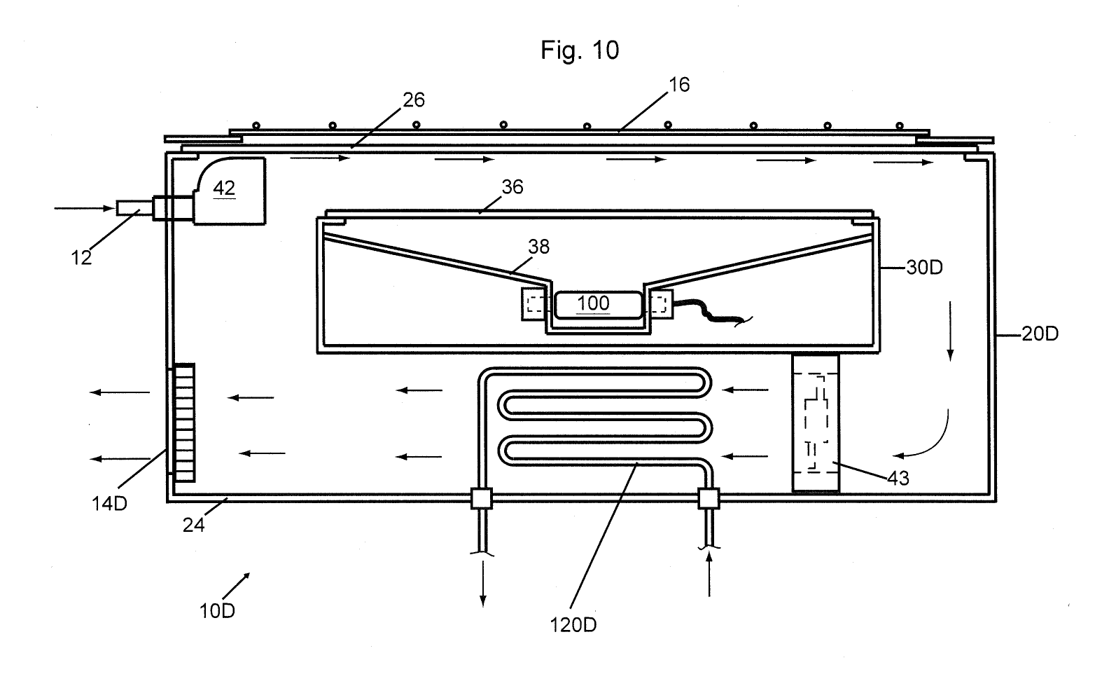

FIG. 10 is a cutaway view of another alternative emitter assembly 10D. In this embodiment, the configuration is similar to that of the embodiment shown in FIG. 9, but instead of a heat sink 120C, there is provided a heat exchanging pipe 120D. A cooling fluid is circulated within the heat exchanging pipe 120D and carries heat from cooling fluid coming into contact with the heat exchanging pipe 120D within the interior of exterior enclosure 20D, to outside of the exterior enclosure 30D, where the heat can be dissipated safely.

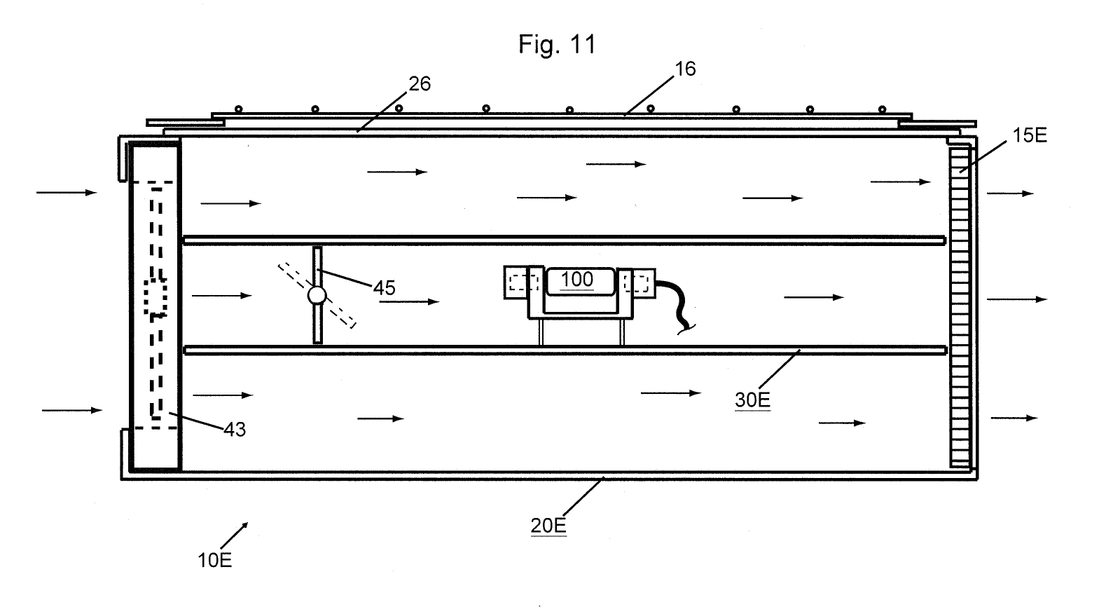

FIG. 11 is a cutaway view of another alternative emitter assembly 10E. In this embodiment, rather than an air knife 42, a large fan 43 directs cooling fluid at a high rate in a straight path through the outer enclosure 20E to be exhausted via filter 15E. The large fan 43 is also positioned to direct cooling fluid at the same high rate through the inner enclosure 30E to be exhausted via filter 15E. In order to provide control over the temperature within the inner enclosure 30E, a temperature-controlled valve 45 opens or closes to permit the cooling fluid into the inner enclosure 30E to a greater or lesser degree. For example, if the valve 45 is opened and a temperature sensor (such as a thermocouple, for example, not shown) senses that the temperature within the inner enclosure 30E is lowering and approaching the second threshold temperature, the valve 45 is closed. In the closed position, the valve 45 prevents cooling fluid from entering into the inner enclosure 30E, and the emitter bulb 100 may therefore preserve or rise in temperature. Similarly, if the valve 45 is closed and the temperature sensor measures that the temperature within the inner enclosure 30E is rising and approaching the third threshold temperature, the valve 45 is opened. In the opened position, the valve permits entry of the cooling fluid into the inner enclosure 30E, and the emitter bulb 100 may therefore preserve or lower in temperature.

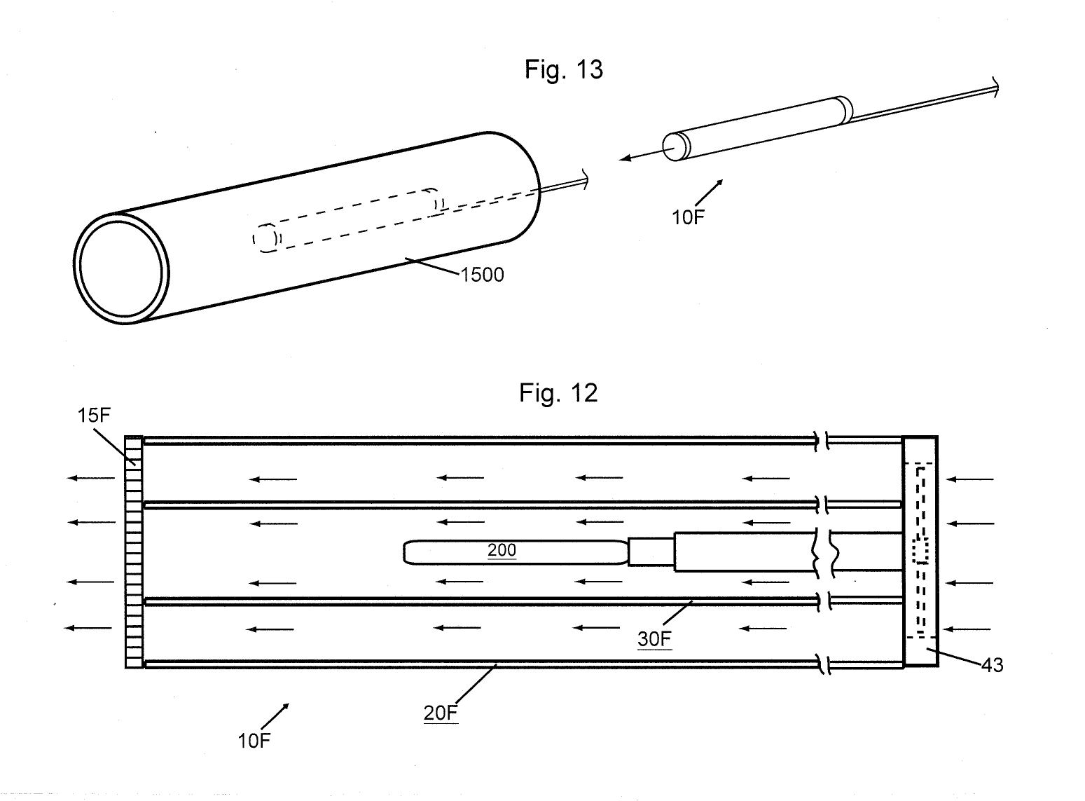

FIG. 12 is a sectional view of another alternative emitter assembly 10F. In this embodiment, the outer enclosure 20F and inner enclosure 30F are generally cylindrical and concentrically arranged with respect to each other. Also, each of the outer enclosure 20F and the inner enclosure 30F are transparent, so that radiation emitted by an emitter 200 from within the inner enclosure 30F may radiate outwards in generally 360 degrees. This embodiment is configured for use in curing coatings on the inside of the pipe or passageway. Due to slight differences in the amount of radiation emitted by the emitter bulb 200 around its 360 degrees (for example, a terminal wire passing along one section of the emitter bulb 200 may simply block some radiation from being emitted along that section), use of the alternative emitter assembly 10E within a pipe or passageway may require some rotation or reciprocation of the alternative emitter assembly 10F as it is being passed into the pipe or passageway, or while it is within the pipe or passageway, to ensure the coating at all positions within the pipe or passageway is receiving a suitable amount of radiation for curing.

As can be seen, cooling fluid is provided to the interior of the exterior enclosure 20F, generally 360 degrees around the interior enclosure 30F, to carry heat out of the emitter assembly 10F. The interior of the interior enclosure 30F is permitted some flow of cooling fluid, but the flow inside the interior enclosure 30F is controlled or regulated to ensure that the temperature within the interior enclosure 30F is maintained at least above a threshold temperature for ensuring that the emitter bulb 200 is within its useful operating range.

FIG. 13 is a perspective view of the alternative emitter assembly 10F of FIG. 12 being inserted into a cylindrical pipe 1500 for curing a coating on the inside of the cylindrical pipe.

Although embodiments have been described, those of skill in the art will appreciate that variations and modifications may be made without departing from the purpose and scope thereof as defined by the appended claims.

For example, while various configurations of inner enclosure, and combinations of inner and outer enclosures have been disclosed and depicted, it will be understood that a number of alternative inner and outer enclosure configurations that suitably shelter the emitter bulb from the cooling fluid to permit it to operate while suitably cooling the outer enclosure interface to keep it from reaching an auto ignition temperature as described herein could be employed.

Furthermore, while walls of the outer and inner enclosures described herein are made of sheets of metal, such enclosures may be constructed of other materials such as composites or plastic.

Furthermore, while a single differential fluid pressure sensor has been described above, in an alternative embodiment the power controller may receive and process signals from two different fluid pressure sensors to determine whether the fluid pressure inside the outer enclosure is greater than that outside of the outer enclosure.

What is claimed is:

1. An emitter assembly comprising:
a generally sealed outer enclosure having an inlet;
a cooling system for directing a cooling fluid via the inlet to inside the outer enclosure to maintain at least the exterior surfaces of the outer enclosure below a first threshold temperature; and
an inner enclosure contained by the outer enclosure and enclosing an emitter bulb, the inner enclosure configured to at least partially shelter the emitter bulb from the flow of cooling fluid to maintain the emitter bulb at or above a second threshold temperature.

2. The emitter assembly of claim 1, wherein the cooling system comprises a gas distribution system within the outer enclosure for distributing a gaseous cooling fluid.

3. The emitter assembly of claim 2, wherein the gas distribution system comprises an air knife for directing gaseous cooling fluid along an inside surface of the outer enclosure.

4. The emitter assembly of claim 2, wherein the gas distribution system comprises one or more of: a vortex cooler, a fan, a nozzle and a blower.

5. The emitter assembly of claim 3, wherein the outer enclosure comprises a transparent window through which radiation from the emitter bulb can be directed, the air knife directing the gaseous cooling fluid in a rapid planar flow along the inside surface of the transparent window to carry heat that is caused by the radiation away from the window.

6. The emitter assembly of claim 1, wherein the inner enclosure is configured to substantially prevent the cooling fluid from contacting the emitter bulb.

7. The emitter assembly of claim 1, wherein the inner enclosure is configured to permit but interrupt the flow of cooling fluid through the inner enclosure.

8. The emitter assembly of claim 7, wherein the inner enclosure comprises at least one port in an exterior wall of the inner enclosure for permitting interrupted flow of cooling fluid into the inner enclosure.

9. The emitter assembly of claim 7, wherein the inner enclosure comprises at least one outlet in an exterior wall of the inner enclosure for permitting interrupted flow of cooling fluid out of the inner enclosure.

10. The emitter assembly of claim 1, wherein the cooling system comprises at least one valve associated with the inner enclosure for controlling the flow of cooling fluid through the inner enclosure based on the temperature of the emitter bulb.

11. The emitter assembly of claim 10, wherein the at least one valve is controlled to reduce flow of cooling fluid into the inner enclosure in the event that the temperature of the emitter bulb drops below the second predetermined temperature, and to permit increased flow of cooling fluid into the inner enclosure in the event that the temperature of the emitter bulb rises above a third predetermined temperature.

12. The emitter assembly of claim 11, wherein the second predetermined temperature and the third predetermined temperature are the bounds of an operating range of the emitter bulb.

13. The emitter assembly of claim 1, wherein the second threshold temperature is the lower limit of an operating temperature range of the emitter bulb.

14. The emitter assembly of claim 1, wherein the first threshold temperature is an auto-ignition temperature of an explosive and/or flammable material that may be in the atmosphere surrounding the emitter assembly.

15. The emitter assembly of claim 1, wherein the cooling system maintains the interior of the outer enclosure at a fluid pressure that is greater than the atmospheric fluid pressure outside of the emitter assembly.

16. The emitter assembly of claim 15, wherein the cooling system comprises a power controller that prevents the emitter bulb from receiving power while the atmospheric fluid pressure is greater than the fluid pressure within the interior of the outer enclosure.

17. The emitter assembly of claim 1, wherein the cooling fluid is selected from the group consisting of: filtered air, nitrogen, another inert gas.

18. The emitter assembly of claim 1, further comprising an exhaust system for exhausting cooling fluid from within the outer enclosure.

19. The emitter assembly of claim 18, wherein the exhaust system comprises a certified spark/flame arrestor.

20. The emitter assembly of claim 19, wherein the spark/flame arrestor is a metal filter.

21. The emitter assembly of claim 19, wherein the spark/flame arrestor is a porous metal.

22. The emitter assembly of claim 1, further comprising:
a reflecting structure within the inner enclosure for directing radiation emitted by the emitter bulb to outside of the inner enclosure.

23. The emitter assembly of claim 22, wherein cooling fluid entering the inner enclosure receives and carries away heat from a side of the reflecting structure that is opposite to the emitter bulb.

24. The emitter assembly of claim 1, wherein the emitter bulb is capable of emitting ultraviolet radiation.
